(19) United States
(12) Patent Application Publication
(10) Pub. No.: US 2024/0295797 A1
(43) Pub. Date: Sep. 5, 2024

(54) SYSTEMS AND CAMERAS FOR TILTING A FOCAL PLANE OF A SUPER-MACRO IMAGE

(71) Applicant: Corephotonics Ltd., Tel Aviv (IL)

(72) Inventors: Noy Cohen, Tel Aviv (IL); Michael Scherer, Tel Aviv (IL)

(21) Appl. No.: 18/655,431

(22) Filed: May 6, 2024

Related U.S. Application Data
(63) Continuation of application No. 18/257,110, filed on Jun. 13, 2023, now Pat. No. 12,007,671.
(60) Provisional application No. 63/288,047, filed on Dec. 10, 2021.
(60) Provisional application No. 63/274,700, filed on Nov. 2, 2021.
(60) Provisional application No. 63/208,186, filed on Jun. 8, 2021.

(51) Int. Cl. G03B 17/12; G03B 5/00; G03B 17/17; G03B 30/00; H04N 23/55; H04N 23/67; H04N 23/69; H04N 23/695; H04N 23/90

(52) U.S. Cl. CPC G03B 17/12; G03B 5/00; G03B 17/17; G03B 30/00; H04N 23/55; H04N 23/67; H04N 23/69; H04N 23/695; H04N 23/90; G03B 2205/0046; G03B 2205/0069

(57) ABSTRACT

Systems comprising a Wide/Ultra-Wide camera, a folded Tele camera comprising an optical path folding element and a Tele lens module, a lens actuator for moving the Tele lens module for focusing to object-lens distances between 3.0 cm and 35 cm with an object-to-image magnification between 1:5 and 25:1, and an application processor (AP), wherein the AP is configured to analyze image data from the UW camera to define a Tele capture strategy for a sequence of Macro images with a focal plane slightly shifted from one captured Macro image to another and to generate a new Macro image from this sequence, and wherein the focal plane and a depth of field of the new Macro image can be controlled continuously.

### CROSS REFERENCE TO RELATED APPLICATIONS

This is a continuation of U.S. patent application Ser. No. 18/257,110 filed Jun. 13, 2023 (now allowed), which was a 371 application from international patent application No. PCT/IB2022/055306 filed Jun. 7, 2022, which claims the benefit of priority from U.S. provisional patent applications Nos. 63/208,186 filed Jun. 8, 2021, 63/274,700 filed Nov. 2, 2021 and 63/288,047 filed Dec. 10, 2021, which are incorporated herein by reference in their entirety.

### FIELD

The subject matter disclosed herein relates in general to macro images and in particular to methods for obtaining such images with mobile telephoto (“Tele”) cameras.

### BACKGROUND

Multi-cameras (of which a “dual-camera” having two cameras is an example) are now widespread in portable electronic mobile devices (or just “mobile devices”, e.g. smartphones, tablets, etc.). A multi-camera usually comprises a wide field-of-view (or “wide angle”) FOV_{W} camera (“Wide” or “W” camera), and at least one additional camera, e.g. with a narrower (than FOV_{W}) FOV, i.e. a “Tele” (or “T”) camera with FOV_{T}. A triple camera including a W camera, an ultra-wide (UW) camera and a double-folded Tele camera is shown in FIG. 5A-B.

A “Macro-photography” mode is becoming a popular differentiator. “Macro-photography” refers to photographing objects that are close to the camera, so that an image recorded on the image sensor is nearly as large as the actual object photographed. The ratio of object size to image size is the object-to-image magnification (“M”).

A Macro camera providing large M can be realized with a mobile devices's Tele camera. Because of its large M, the camera can be referred to as “super-Macro camera” or “SM camera” and the image can be referred to as “super-Macro image” or “SM image”. Tele cameras and methods for mobile super-Macro-photography are described for example in co-owned international patent application PCT/IB2021/054186.

Because of a Tele camera's large effective focal length (EFL) of 7 mm or more, Tele cameras focused to close objects have a very shallow depth of field (DOF), see Table 1. The DOF is the distance between the nearest and the farthest objects that are in acceptably sharp focus in an image. Consequently, capturing Macro images in a Macro-photography mode with a Tele camera is very challenging. For example, for obtaining more beneficial lightning or more convenient capture experience, one may want to capture an object which is oriented at some angle θ with respect to the mobile device's rear surface and the Macro camera's focal plane (see FIG. 1A). This may result in an image that is only partially in focus. In standalone cameras such as digital single-lens reflex cameras (DSLRs), this challenge is solved by “Tilt-shift lenses” that allow to tilt the focal plane. However, there is no satisfactory solution to this challenge in miniature cameras of the type included in smartphones.

It would be beneficial to have a super-Macro camera in mobile devices that can tilt its focal plane.

### SUMMARY

In various embodiments there is provided a camera, comprising: an object side optical path folding element (O-OPFE) for folding a first optical path (OP1) to a second optical path (OP2); a lens; an image side optical path folding element (I-OPFE) for folding OP2 to a third optical path (OP3), wherein OP1 and OP2 and OP3 are perpendicular to each other; an I-OPFE actuator; and an image sensor with an image plane oriented parallel to a X-Y plane in an exemplary orthogonal XYZ coordinate system, wherein the camera is a super-Macro (SM) camera and has a focal plane, wherein in a zero-tilt focal plane position the focal plane is parallel to a X-Z plane, wherein in a zero-tilt I-OPFE position the I-OPFE forms an angle of 45 degrees with both the X-axis and the Z-axis and is parallel to the Y-axis, wherein the I-OPFE actuator is operative to tilt the focal plane around a first focal plane rotation axis that is parallel to the Z-axis by rotational actuation of the I-OPFE around a first I-OPFE rotation axis that is parallel to the Y-axis, and/or to tilt the focal plane around a second focal plane rotation axis parallel to the X-axis by rotational actuation of the I-OPFE around a second I-OPFE rotation axis that is parallel to the zero-tilt I-OPFE position and perpendicular to the Y-axis.

In some embodiments, OP1 and OP3 are oriented parallel to the Y-axis and OP2 is oriented parallel to the X-axis, wherein the image sensor is oriented parallel to the X-Z plane, wherein the I-OPFE actuator is operative to tilt the focal plane around the first focal plane rotation axis by rotational actuation of the I-OPFE around a third I-OPFE rotation axis that is parallel to the Z-axis, and/or to tilt the focal plane around the second focal plane rotation axis by rotational actuation of the I-OPFE around a fourth I-OPFE rotation axis that is parallel to the zero-tilt I-OPFE position and perpendicular to the Z-axis.

In some embodiments, the SM camera is focused to object-lens distances of 3.0-15 cm.

In some embodiments, the SM camera is focused to object-lens distances of 15-50 cm.

In some embodiments, the focal plane is tilted by 0-20 degrees around the first focal plane rotation axis and/or the second focal plane rotation axis.

In some embodiments, the I-OPFE is tilted by 0-40 degrees around the first I-OPFE rotation axis or the third I-OPFE rotation axis for tilting the focal plane by 0-20 degrees around the first focal plane rotation axis, and/or the I-OPFE is tilted by 0-40 degrees around the second I-OPFE rotation axis or the fourth I-OPFE rotation axis for tilting the focal plane by 0-20 degrees around the second focal plane rotation axis. In some embodiments, the I-OPFE is tilted by 0-60 degrees around the first I-OPFE rotation axis or the third I-OPFE rotation axis for tilting the focal plane by 0-40 degrees around the first focal plane rotation axis and/or the I-OPFE is tilted by 0-60 degrees around the second I-OPFE rotation axis or the fourth I-OPFE rotation axis for tilting the focal plane by 0-40 degrees around the second focal plane rotation.

In some embodiments, the focal plane is tilted by 0-40 degrees around the first focal plane rotation axis and/or the second focal plane rotation axis. In some embodiments, the focal plane is tilted by 0-60 degrees around the first focal plane rotation axis and/or the second focal plane rotation axis. In some embodiments, the focal plane is tilted by 0-80 degrees around the first focal plane rotation axis and/or the second focal plane rotation axis.

In some embodiments, calibration data is used to calculate control signals for tilting the focal plane around the first focal plane rotation axis and the second focal plane rotation axis, and the calibration data is dependent on the distance between the SM camera and an object to be captured.

In some embodiments, a first rotation stroke around the first or the second or the third or the fourth I-OPFE rotation axis is required for tilting the focal plane around the first focal plane rotation axis or the second focal plane rotation axis by a particular focal plane tilt stroke when the focal plane is located at a first distance from the SM camera, a second rotation stroke around the first or the second or the third or the fourth I-OPFE rotation angle is required for tilting the focal plane around the first focal plane rotation axis or the second focal plane rotation axis by the same particular focal plane tilt stroke when the focal plane is located at a second distance from the SM camera, the second distance is larger than the first distance, and the first rotation stroke is smaller than the second rotation stroke.

In some embodiments, the SM camera has an effective focal length (EFL) of 7-10 mm. In some embodiments, the SM camera has an EFL of 10-20 mm. In some embodiments, the SM camera has an EFL of 20-40 mm.

In some embodiments, the I-OPFE actuator is a voice coil motor.

In some embodiments, the I-OPFE is a mirror.

In some embodiments, the O-OPFE is a prism.

In some embodiments, the lens is partitioned into two lens groups, wherein a first lens is located at an object side of the O-OPFE and a second lens group is located between an image side of the O-OPFE and an object side of the I-OPFE.

In some embodiments, the SM camera is a scanning camera that scans a scene with a respective SM field-of-view.

In some embodiments, the SM camera can be switched between two or more discrete zoom states.

In some embodiments, the SM camera can be switched continuously between a minimum zoom state and a maximum zoom state.

In some embodiments, a zoom factor of a maximum zoom state is twice a zoom factor of a minimum zoom state.

In some embodiments, a zoom factor of a maximum zoom state is 3 times larger than a zoom factor of a minimum zoom state.

In various embodiments, there is provided a mobile device comprising a camera as above or below and including an application processor (AP) configured to control the tilting of the focal plane.

In some embodiments, the mobile device is a smartphone.

In some embodiments, the AP is configured to use calibration data including rotation angles of the first and/or the second and/or the third and/or the fourth I-OPFE rotation axes, and object-lens distances for controlling the tilting of the focal plane around the first and/or the second focal plane rotation axes.

In some embodiments, the AP is configured to control the tilting of the focal plane according to a user input.

In some embodiments, the AP is configured to run an algorithm to tilt the focal plane automatically.

In some embodiments, the AP is additionally configured to automatically capture an image or a stream of images after the focal plane is tilted.

In some embodiments, the focal plane is tilted so that an object of interest captured with the SM camera is entirely in-focus.

In some embodiments, the focal plane is tilted so that an object of interest captured with the SM camera has a specific amount of out-of-focus deblur.

In some embodiments, a mobile device further comprises a Wide camera and/or an Ultra-Wide camera, wherein the AP is additionally configured to analyze image data from any of the SM camera, the Wide camera, or the Ultra-Wide camera for tilting the focal plane automatically.

In some embodiments, the image data is photodiode autofocus image data. In some embodiments, the analysis of image data uses a saliency map and/or an object detection algorithm.

In some embodiments, the AP is configured to analyse image data from the Wide camera or the Ultra-Wide camera to steer a field-of-view (FOV) of the scanning camera towards a specific segment within a FOV of the Wide camera.

In some embodiments, the AP is configured to analyse image data from the Wide camera or the Ultra-Wide camera to switch the SM camera to a specific zoom state for capturing Macro images which have a specific magnification and a specific field-of-view.

In various embodiments there is provided a method, comprising: providing an electronic mobile device that includes a Wide camera for capturing a Wide image with a respective Wide field of view (FOV_{W}), a SM camera for capturing a SM image with a respective SM field of view smaller than FOV_{W}, wherein the SM camera is configured to tilt its focal plane, and a processor; and configuring the processor to autonomously tilt the focal plane of the SM camera according to an analysis that uses Wide image data and/or SM image data and to autonomously capture SM images at a given focal plane tilt.

In some embodiments, the tilting of the focal plane is performed so that a captured SM image is entirely in-focus.

In some embodiments, the tilting of the focal plane is performed so that a captured SM image has a specific amount of out-of-focus deblur.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein, and should not be considered limiting in any way. Like elements in different drawings may be indicated by like numerals. Elements in the drawings are not necessarily drawn to scale.

FIG. 1A shows an exemplary SM capture scenario known in the art;

FIG. 1B shows a SM image captured in a Portrait mode according to the scenario shown in FIG. 1A;

FIG. 2A shows exemplarily a SM image capture scenario as disclosed herein;

FIG. 2B shows a SM image captured in a Portrait mode according to the scenario shown in FIG. 2A;

FIG. 3A shows an example of a known art double-folded camera in a cross-sectional view;

FIG. 3B shows an example of a double folded camera with a tiltable focal plane disclosed herein in a cross-sectional view;

FIG. 4A shows exemplarily a camera disclosed herein in a zero-tilt focal plane position;

FIG. 4B shows the camera of FIG. 4A in a non-zero tilt focal plane position;

FIG. 4C shows an embodiment of a method for automatic control of focal plane tilting disclosed herein;

FIG. 5A shows an example of a mobile device that includes a double-folded SM camera with a tiltable focal plane as disclosed herein;

FIG. 5B shows a known art double-folded Tele camera in a perspective view;

FIG. 6A shows an I-OPFE module disclosed herein from a top view;

FIG. 6B shows the I-OPFE module of FIG. 6A without an I-OPFE and without an OPFE holder in a perspective view;

FIG. 6C shows the I-OPFE module in the same perspective view as FIG. 2B, but with the I-OPFE and the OPFE holder shown;

FIG. 7 shows schematically an embodiment of a mobile device capable of tilting a focal plane disclosed herein.

### DETAILED DESCRIPTION

Cameras and images below qualify as “SM” if they support the two criteria:
M of 1:5-25:1.
Capture at an object-lens distance in the range of 30 mm-750 mm with an EFL in the range of 7 mm-50 mm.

A magnification of 1:5 and 25:1 refers respectively to a ratio of the physical size of the captured object being 1 and 25 to a size of the image of the captured object being 5 and 1, respectively.

It is noted that the above SM definition refers to both camera specifications (e.g. EFL in the range of 7 mm-50 mm) and image (or scene) specifications (e.g. object-lens distance in the range of 30 mm-750 mm). In particular, this means that a same camera may be used for image capture both in SM scenes (e.g. a scene with an exemplary object-lens distance of 100 mm) as well in other scenes (e.g. a scene with an exemplary object-lens distance of 2 m). When capturing SM scenes, the camera is referred to as SM camera. When capturing other scenes, the camera is referred to as Tele camera.

Table 1 shows the depth of field (DOF) in mm of a SM camera as function of its EFL (in mm) and an object's distance from the camera (“object-lens distance” or “u”) in cm. For calculating DOF, a f number of f/3 and a circle of confusion of 1.5 μm was assumed. The DOF is presented for a range of EFL=8 mm-40 mm (column) and u=2 cm-150 cm (row).

TABLE 1

| EFL | u(cm) | | | | | | |
|---|---|---|---|---|---|---|---|
| (mm) | 2 | 10 | 15 | 20 | 50 | 100 | 150 |
| 8 | 0.056 | 1.406 | 3.164 | 5.625 | 35.156 | 140.625 | 316.406 |
| 12 | 0.025 | 0.625 | 1.406 | 2.500 | 15.625 | 62.500 | 140.625 |
| 15 | 0.016 | 0.400 | 0.900 | 1.600 | 10.000 | 40.000 | 90.000 |
| 20 | | 0.225 | 0.506 | 0.900 | 5.625 | 22.500 | 50.625 |
| 25 | | 0.240 | 0.540 | 0.960 | 6.000 | 24.000 | 54.000 |
| 30 | | 0.167 | 0.375 | 0.667 | 4.167 | 16.667 | 37.500 |
| 35 | | 0.122 | 0.276 | 0.490 | 3.061 | 12.245 | 27.551 |
| 40 | | 0.094 | 0.211 | 0.375 | 2.344 | 9.375 | 21.094 |

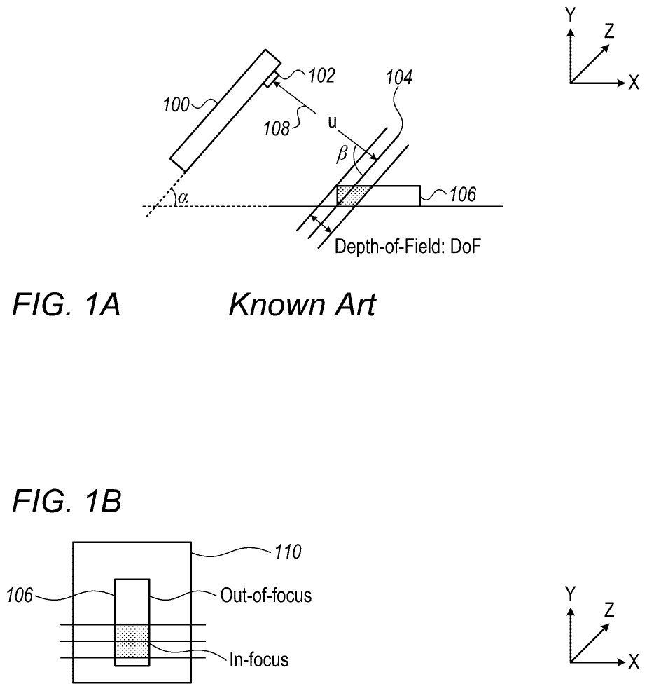

FIG. 1A shows an exemplary SM capture scenario known in the art. Mobile device 100 (e.g. a smartphone) includes a SM camera 102 that has a focal plane 104. Focal plane 104 is oriented in parallel to a rear surface of mobile device 100 and has a certain DOF. The DOF extends to both sides of focal plane 104. SM camera 102 captures an object 106. Mobile device 100 is oriented at an angle α with respect to the orientation of object 106. Because of the shallow DOF (see Table 1), only parts of object 106 may lie within the DOF region and may be in focus (dotted area of object 106). Other parts of object 106 may lie outside the DOF region and may be out of focus (white area of object 106). Focal plane 104 forms an angle β=90 degrees with a normal 108 of mobile device 100's rear surface. Mobile device 100 is shown in “Portrait mode” orientation as known in the art, meaning that a length dimension of a camera image is parallel to a length dimension of the object. In other embodiments, mobile device 100 may be in “Landscape mode” orientation as known in the art.

FIG. 1B shows a SM image 110 captured in a Portrait mode according to the scenario shown in FIG. 1A. Only segments of object 106 that were within the DOF are in-focus, and the segments of object 106 that were outside of the DOF are out-of-focus. In this scenario, the DOF of the SM camera prevents all-in-focus object capture in a direction parallel to the image's Y-axis. In other scenarios, the DOF of the SM camera may prevent all-in-focus object capturing in a perpendicular direction that is parallel to the image's X-axis.

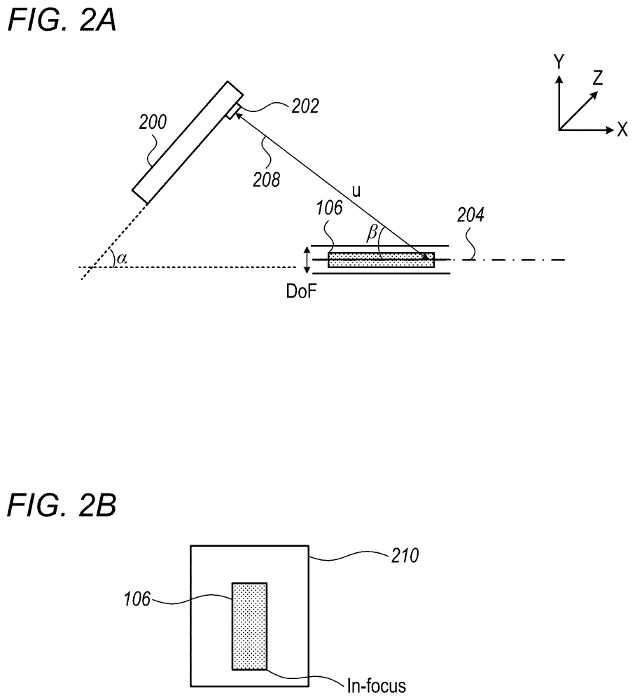

FIG. 2A shows exemplarily a SM image capture scenario as disclosed herein. Mobile device 200 (e.g. a smartphone) includes a SM camera 202 with a tiltable focal plane 204. “Tiltable” refers to the fact that focal plane 204 can be tilted to have an orientation that is not parallel to mobile device 200. Focal plane 104 forms an angle β<90 degrees with a normal 208 of mobile device 200's rear surface.

SM camera 202 captures object 106. As in the scenario of FIG. 1A, mobile device 200 is oriented at an angle α with respect to the orientation of object 106. However and in contrast, focal plane 204 of SM camera 202 is tilted around a rotation axis parallel to the Z-axis so that focal plane 204 is oriented parallel to object 106. Despite the shallow DOF, all segments of object 106 lie within the DOF region and are thus in focus. Like mobile device 100 in FIG. 1A, mobile device 200 is shown in Portrait mode orientation.

FIG. 2B shows a SM image 210 captured in a Portrait mode according to the scenario shown in FIG. 2A. All segments of object 106 are in focus.

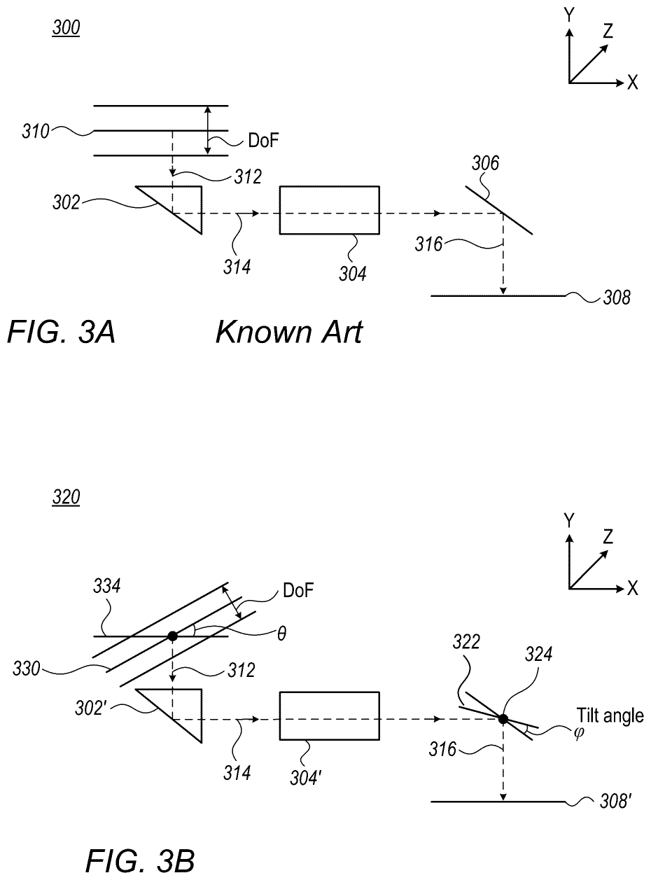

FIG. 3A shows an example of a first example of a known art double-folded camera numbered 300 in a cross-sectional view. Camera 300 includes a first object-side optical path folding element (“object OPFE” or “O-OPFE”, for example a prism or a mirror) 302, a lens 304, a second image-side OPFE (“image OPFE” or “I-OPFE”—for example a mirror or a prism) 306 and an image sensor 308. Image sensor 308 is oriented in a plane parallel to the X-Y plane. Camera 300 has a focal plane 310 that is oriented parallel to the X-Z plane, i.e. perpendicular to image sensor 308 and parallel to a rear surface of a mobile device (not shown) that hosts camera 300. The optical path (“OP”) of camera 300 is folded twice, from a first OP (“OP1”) 312 that is perpendicular to focal plane 310 and parallel to the Y-axis, to a second OP (“OP2”) 314 that is parallel to focal plane 310 and parallel to the X-axis, and then to a third OP (“OP3”) 316 that is perpendicular to focal plane 310 and parallel to the Z-axis. I-OPFE 306 is oriented at an angle of 45 degrees with respect to image sensor 308 and with respect to both OP2 314 and OP3 316. In the following, this orientation of I-OPFE 306 is referred to as an I-OPFE's “zero-position” or “zero-tilt position”. In a second example of a known art double folded camera (not shown), OP3 316 is oriented parallel to OP1 312 (i.e. parallel to the Y-axis) and image sensor 308 may be oriented in a plane parallel to the X-Z plane.

FIG. 3B shows an example of a first example of a double folded camera 320 with a tiltable focal plane 330 disclosed herein in a cross-sectional view. Similar to camera 300, camera 320 includes an O-OPFE 302′, a lens 304′ and an image sensor 308′ which may or may not be identical with respective elements in camera 300. In addition, camera 320 includes a tiltable I-OPFE 322 (for example a mirror or a prism). In other embodiments, lens 304′ may be partitioned into two or more lens groups (not shown), wherein a first lens group including one or more lens elements may be located at an object side of O-OPFE 302′ and a second lens group including one or more lens elements may be located at an image side of O-OPFE 302′ and at an object side of tiltable I-OPFE 322. In yet other embodiments (not shown), lens 304′ may be located at an object side of O-OPFE 302′, i.e. no lens elements may be located at an image side of O-OPFE 302′. The OP of camera 320 is folded twice, with identical partition into three OPs as shown in FIG. 3A. In particular, this means that image sensor 308′ is oriented parallel to the X-Y plane and that tiltable focal plane 330 (in a zero-position) is oriented parallel to the X-Z plane. Tiltable I-OPFE 322 is shown in a zero-tilt position (like 306 in FIG. 3A) and in a tilted position with a tilt angle of φ with respect to its zero-tilt position. In a zero-tilt position, tiltable I-OPFE 322 is oriented parallel to the Y-axis and oriented at an angle of 45 degrees with respect to image sensor 308′ and to OP2 314 (which is parallel to the X-axis) and OP3 316 (which is parallel to the Z-axis).

Here and in the following, a first I-OPFE tilt angle “o” is defined by the rotation angle of I-OPFE 322 around a first I-OPFE rotation axis 324 that is parallel to the Y-axis and which may intersect the geometrical center of the reflecting surface of I-OPFE 322. By tilting I-OPFE 322 around first I-OPFE rotation axis 324, tiltable focal plane 330 is tilted around a first focal plane tilt axis that is parallel to the Z-axis.

A second I-OPFE tilt angle is defined by the rotation angle of I-OPFE 322 around a second I-OPFE rotation axis (not shown) that is parallel to I-OPFE 322's zero-tilt position, i.e. second I-OPFE rotation axis forms an angle of 45 degrees with both the X-axis and the Z-axis and is perpendicular to the Y-axis. By tilting I-OPFE 322 around the second I-OPFE rotation axis, tiltable focal plane 330 is tilted around a second focal plane tilt axis that is parallel to the X-axis.

Depending on an orientation of an object that is to be captured such as object 106, it may be desired to tilt focal plane 330 around the first focal plane tilt axis, around the second focal plane tilt axis, or around a combination of the two. Given an orientation of a particular object that is to be captured such as object 106, it may be desired to tilt focal plane 330 around the first focal plane tilt axis when a mobile device including camera 320 (such as mobile device 700) is held in a Portrait mode (or orientation) as known in the art for image capture, and it may be desired to tilt focal plane 330 around the second focal plane tilt axis when a mobile device including camera 320 is held in a Landscape mode as known in the art for image capture, or vice versa. This means that the decision whether to tilt the focal plane around the first or the second tilt axis depends both on the orientation of an object to be captured and on the orientation of the camera hosting mobile device.

For tilting a focal plane of a second example double folded camera (i.e. OP3 being parallel to the Y-axis and the image sensor being oriented in a plane parallel to the X-Z plane) around a first focal plane tilt axis that is parallel to the Z-axis, the I-OPFE may be tilted around an I-OPFE tilt axis that is parallel to the Z-axis. For tilting a focal plane of a second example double folded camera around a second focal plane tilt axis that is parallel to the X-axis, the I-OPFE may be tilted around an I-OPFE tilt axis that is parallel to the I-OPFE as well as oriented perpendicular to the Z-axis and forming an axis of 45 degrees with respect to the X-axis and the Y-axis.

Tiltable focal plane 330 of camera 320 is a tilted focal plane that is not perpendicular to OP 312, but forms an angle θ with a plane 334 that is oriented normal to OP 312. With reference to FIG. 1A and FIG. 2A, camera 320 can be used to capture an object such as 106 entirely in focus, if focal plane tilting is performed so that θ=α is approximately fulfilled (a being the angle between mobile device 200 and object 106, see FIG. 2A). “Approximately fulfilled” means here that because of the finite thickness of DOF (as shown in FIG. 1A and FIG. 2A), an object like object 106 can be captured entirely in focus also at an angle θ=α±Δ. The magnitude of A depends on angle α and on object-lens distance “u”.

For a tiltable focal plane such as 330, the object-lens distance u for an object in focus is measured along OP 312 from the FOV center to the camera lens. As can be seen in FIG. 3B, the tilting of the focal plane does not change u. In double folded camera 320, consecutive OPs (such as OP1 and OP2, OP2 and OP3 etc.) are oriented perpendicular to each other. In other examples, consecutive OPs may be oriented to each other at another angle, e.g. varying from 90 degrees by 10 degrees or 20 degrees or more. In particular, here an O-OPFE and/or an I-OPFE in a zero-tilt position may be oriented so that it folds an optical path towards the another angle.

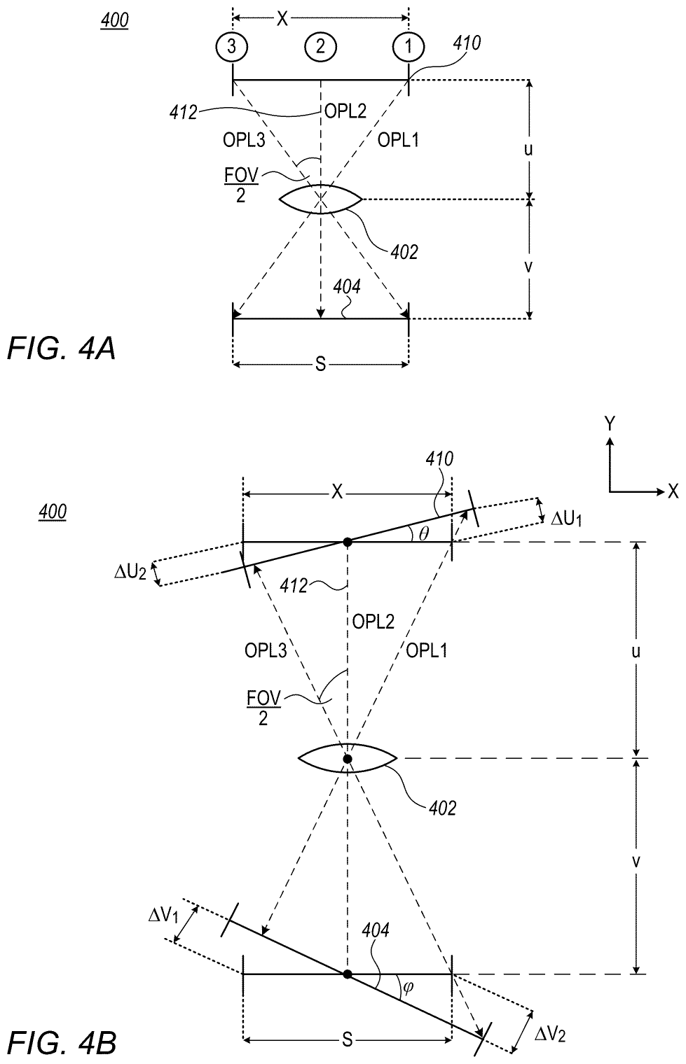

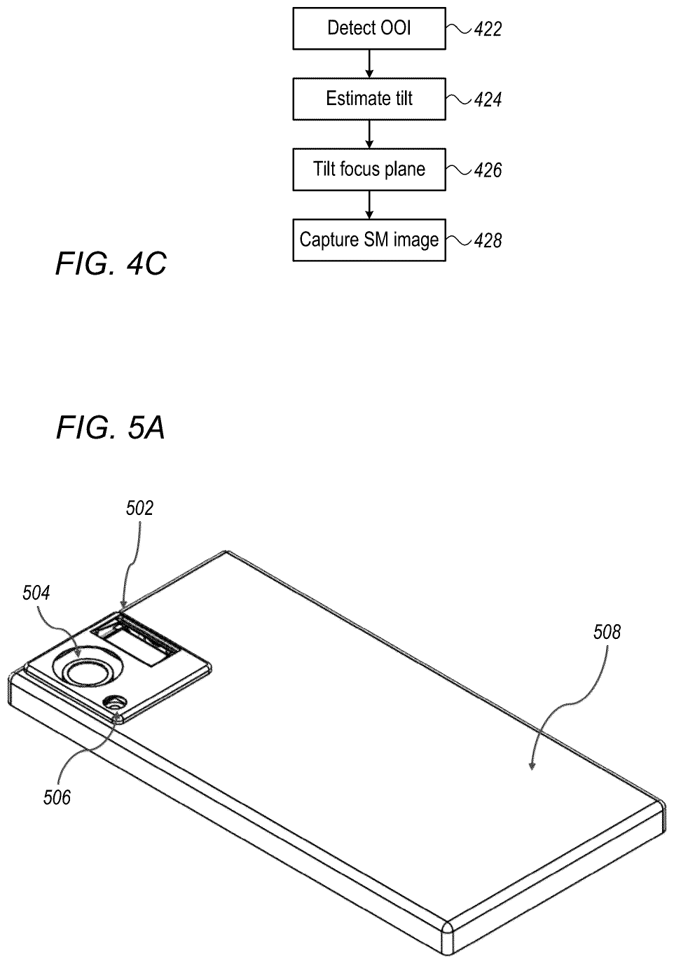

FIGS. 4A-B show the relation between tilting angles φ and θ (as defined in FIG. 3B). For the sake of simplicity, the optical system of double-folded camera 320 is represented by a simpler regular or non-folded camera 400. For not too large angles q for example up to φ=20 degrees, it can be assumed that tilting an image sensor of a non-folded camera such as image sensor 404 (similar to 308′) by angle φ with respect to its zero-tilt position at 90 degrees to the camera's OP 412 (similar to 316) leads to a similar tilting angle θ as one obtains by tilting an I-OPFE such as I-OPFE 322 by the same tilting angle φ with respect to its zero-tilt position (at 45 degrees with respect to the double-folded camera's OP 314 and OP 316). It is noted that this implies that focal plane tilting as described herein can be performed not only by a double-folded camera, but also by a regular or non-folded camera. Whereas in a double-folded camera such as 320 an I-OPFE such as 322 is tilted for focal plane tilting, in a regular camera the camera's lens is tilted with respect to the camera's image sensor and a mobile device hosting the regular camera, or the camera's image sensor is tilted with respect to the camera's lens and a mobile device hosting the regular camera.

FIG. 4A shows exemplarily camera 400 in a zero-tilt focal plane position. Camera 400 includes a lens 402 and a tiltable image sensor 404 and it is focused to a focal plane 410 perpendicular to the Y-axis to some object-lens distance u, covering a certain horizontal field of view (FOV) of a scene. Tiltable image sensors are known in the art. In FIG. 4A, image sensor 404 is shown in a zero-tilt position. In the zero-tilt position, image sensor 404 is oriented perpendicular to the Y-axis. As known in the art, the optical system is designed so that focal plane 410 is oriented parallel to image sensor 404, parallel to a rear surface of a mobile device (not shown) that hosts camera 400 and perpendicular to OP 412 of camera 400. Three exemplary field (or “object”) points (with rays numbered 1-3) are shown: a first field point (“FP1”) at a position right of a center of the FOV, a second field point (“FP3”) at the FOV center and a third field point (“FP3”) at a position left of the FOV center. Designing the optical system so that the focal plane 410 of camera 400 is oriented parallel to image sensor 404 means that fields 1-3 at a same object-lens distance u are in focus. Field points at u are in focus if all rays emerging from this field point propagate a same optical path length (“OPL”), so all rays of FP1, FP2 and FP3 propagate a specific OPL (respectively OPL1, OPL2 and OPL3). OPL1, OPL2 and OPL3 come to lie on focal plane 410. The width of sensor 404 is marked “S”, while the width of the FOV is marked “X”.

FIG. 4B shows camera 400 in a non-zero tilt focal plane position. Image sensor 404 is now tilted, oriented in a plane not perpendicular to the Y-axis, but forming an angle φ with the X-axis. When image sensor 404 is tilted, OPL1, OPL2 and OPL3 do not come to lie on a focal plane 410 perpendicular to the Y-axis, but on a focal plane 410 that forms some an angle≈90 degrees with the Y-axis and an angle θ with the X-axis. Object-lens distance u and lens-image distance v are not constant with respect to x such as shown in FIG. 4A, but depend on x, i.e. u=u(x) and v=v(x). For FP1, u1=u_{center}+Δu1 and v1=V_{center}+Δv1. For FP3, u3-u_{center}+Δu3 and v3=V_{center}+Δv3. “u_{center}” and “V_{center}” refer to an object-lens distance at a center position of the FOV and a lens-image distance at a center position of the image sensor respectively. For FP2, there is no change, u2=u_{center} and v2=V_{center}. We assume that FP1 and FP3 are located symmetrically with respect to FP2, so that Δu1=−Δu3 and Δv1=−Δv3. In the following, we will consider FP1 only. If not stated otherwise explicitly, here and in the following the object-lens distance u refers to u_{center}.

The thin lens equation depends now on x, too (equation 1):

$$\frac{1}{EFL} = \frac{1}{u ( x )} + \frac{1}{v ( x )}$$

Tables 2-4 show exemplarily the relationship of focal plane tilt stroke θ and combinations of SM camera examples (characterized by EFL in mm) and object-lens distances u (in mm) for three image sensor tilt angles φ1=5 deg (Table 2), φ2=20 deg (Table 3) and φ3=40 deg (Table 4).

TABLE 2
(φ1 = 5 deg)

| | u(mm) | | |
|---|---|---|---|
| EFL (mm) | 60 | 100 | 160 |
| 15 | 6.66 | | 5.52 |
| 20 | 7.49 | 6.25 | 5.71 |
| 30 | 9.96 | 7.14 | 6.20 |

TABLE 3
(φ2 = 20 deg)

| | u(mm) | | | | |
|---|---|---|---|---|---|
| EFL (mm) | 60 | 100 | 160 | 500 | 1000 |
| 15 | 26.38 | 23.42 | 22.01 | 20.60 | 20.30 |
| 20 | 29.43 | 24.82 | 22.77 | 20.80 | 20.4 |
| 30 | 37.88 | 28.13 | 24.45 | 21.20 | 20.60 |

TABLE 4
(φ3 = 40 deg)

| | u(mm) | | |
|---|---|---|---|
| EFL mm | 100 | 500 | 1000 |
| 15 | 46.20 | 41.10 | 40.60 |
| 20 | 48.60 | 41.50 | 40.70 |
| 30 | 54.10 | 42.30 | 41.10 |

From Tables 2-4 it is evident that for tilting the focal plane around a first focal plane rotation axis or a second focal plane rotation axis by a particular focal plane tilt stroke θₚ (“P” for particular), a particular I-OPFE rotation stroke φₚ is required, wherein φₚ is smaller for closer object-lens distances u. This means that for performing a same focal plane tilt stroke θₚ at two different object-lens distances u₁, u₂, wherein u₁<u₂, at u₁ a smaller amount of rotation (i.e. a smaller rotation stroke Pp) of the I-OPFE is required than at u₂. In other words, for a particular amount of focal plane tilting the following is fulfilled: the smaller the object-lens distance, the smaller the required I-OPFE rotation stroke φₚ to achieve the particular amount of focal plane tilting.

The tilting of the focal plane may be by controlled by a human user or automatically by an algorithm.

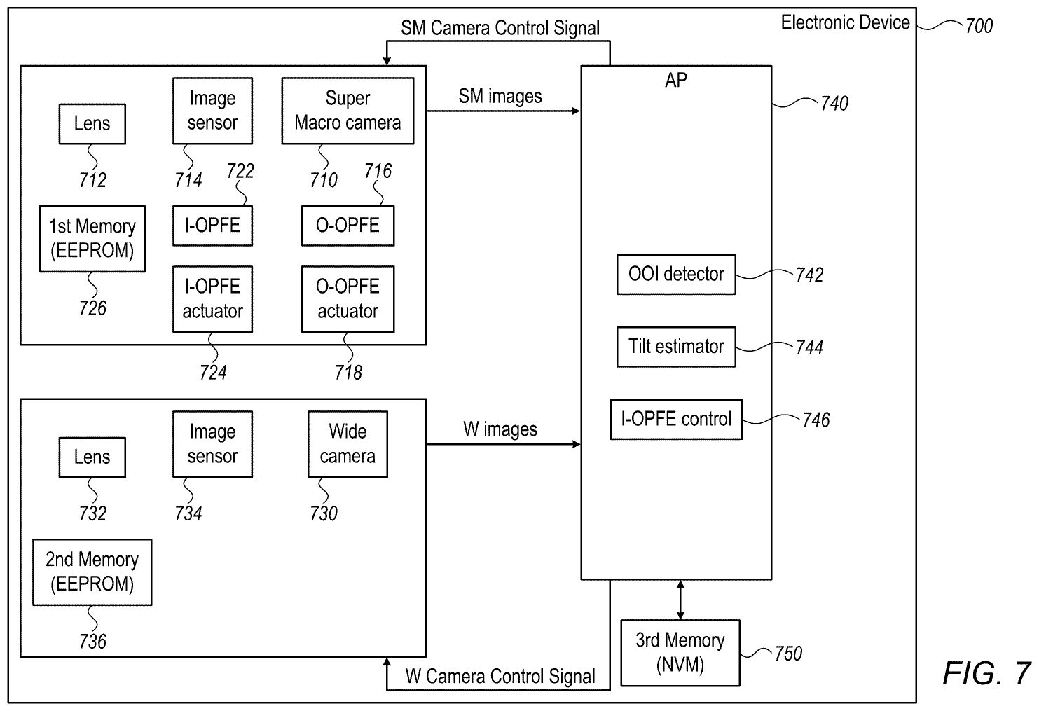

FIG. 4C shows an embodiment of a method for automatic control of focal plane tilting disclosed herein. In a first step 422, an object of interest (“OOI”) detector such as OOI detector 742 (FIG. 7) may detect an OOI and its position within a SM camera's FOV. The OOI may be selected by a user and/or proposed by an algorithm, e.g. by using a saliency map or an object detection algorithm. In some embodiments, OOI detector 742 may use Wide (W) or Ultra-wide (UW) image data for detecting an OOI. In step 424, a tilt estimator such as tilt estimator 744 (FIG. 7) may calculate a relative tilt between the SM camera's focal plane and the OOI. For tilt estimation, image data from the SM or the W or UW camera may be used, e.g. RGB or photodiode autofocus (PDAF) image data. In other embodiments, depth map data from an additional camera, e.g. from a Time-of-Flight (TOF) camera may be used. Based on the tilt estimation, in step 426 I-OPFE control 746 (FIG. 7) may use calibration data such as presented in Table 2-4, e.g. as a Look-Up-Table (LUT), to calculate I-OPFE control signals that are transmitted to an I-OPFE actuator (such as I-OPFE actuator 724) which tilts the focal plane in order to align the SM camera's focal plane with OOI's orientation.

The calibration data may include tilt angles of four I-OPFE rotation axes and object-lens distances for controlling the tilting of the focal plane around two focal plane rotation axes. The calibration data may include tilt angles of two I-OPFE rotation axes and object-lens distances for controlling the tilting of the focal plane around one focal plane rotation axis. In other embodiments, the focal plane may not be aligned with the OOI orientation, but the focal plane and the OOI orientation may be tilted with respect to each other in a defined way, so that an artistic (or aesthetic) combination of in-focus and out-of-focus segments in the SM image are formed. For example, the artistic combination of in-focus and out-of-focus segments in the SM image may be a Bokch effect that can be controlled via focal plane tilting. In some examples, the artistic combinations may be used to highlight particular objects or particular segments of a scene.

In other examples referring to a regular or non-folded camera, in step 426 a lens tilt controller or an image sensor tilt controller may use calibration data to calculate lens control signals or image sensor control signals that tilt the focal plane by tilting the camera's lens and/or the camera's image sensor in order to align the focal plane and OOI's orientation.

In yet other examples referring to a camera that has an optical path which is folded more than twice, e.g. 3 times or 4 times or more, in step 426 an OPFE tilt controller may use calibration data to calculate OPFE control signals that tilt the focal plane by tilting one of the camera's OPFEs by means of an OPFE actuator in order to align the focal plane and the OOI orientation. A camera that has an optical path which is folded 3 times or 4 times respectively includes two or more OPFEs (e.g. prisms and/or mirrors) and has 4 optical path segments OP1-OP4 or 5 optical path segments OP1-OP5 respectively, wherein consecutive OPs (such as OP1 and OP2 etc.) may be oriented at an angle of 90 degrees relative to each other or they may be oriented at another angle.

In step 428, a SM image is captured. In some embodiments, a plurality of SM images is captured that together form a video stream. In some examples, different artistic combinations of in-focus and out-of-focus segments in particular SM images of the video stream may be used to highlight particular objects or particular segments of a scene.

In some embodiments and for a scanning SM camera, W image data may be used to steer the native FOV_{N} of the scanning SM camera to an OOI.

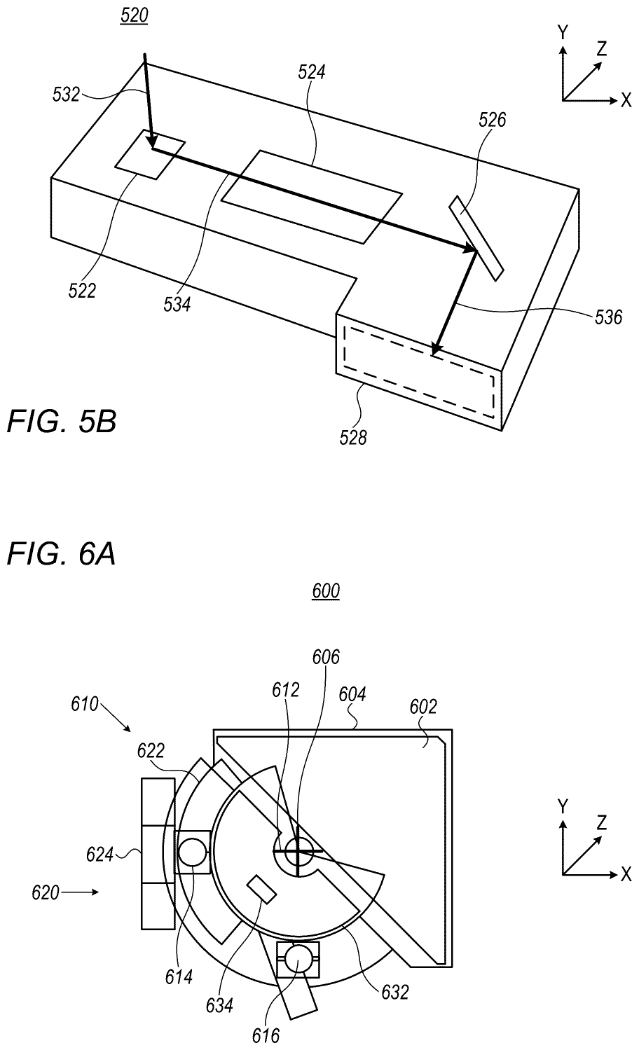

FIG. 5A shows an example of a mobile device numbered 500 that includes a double-folded SM camera 502 with a tiltable focal plane as disclosed herein. Mobile device 500 includes a multi-camera that comprises, in addition to a Tele camera that acts as SM camera 502, a Wide (or “W”) camera 504 having a Wide FOV_{W} and an Ultra-Wide (or “UW”) camera 506 having an Ultra-Wide FOV_{uw}. The multi-camera is integrated in the rear-facing (or world-facing) surface 508 of mobile device 500. Mobile device 500 may include some or all of components of mobile device 700. Mobile device 500 may for example be a smartphone.

FIG. 5B shows a known art double-folded Tele camera 520 in a perspective view. Camera 520 includes an object OPFE 522 (e.g. a prism), a lens 524, an I-OPFE 526 (e.g. a mirror) and an image sensor 528. Camera 520 has three OPs, OP1 532, OP2 534 and OP3 536. Double-folded Tele camera 520 is implemented according to the first example as described above, i.e. OP1 532 is parallel to the Y-axis, OP2 534 is parallel to the X-axis, OP3 536 is parallel to the Z-axis. Image sensor 528 is oriented in a plane parallel to the X-Y plane.

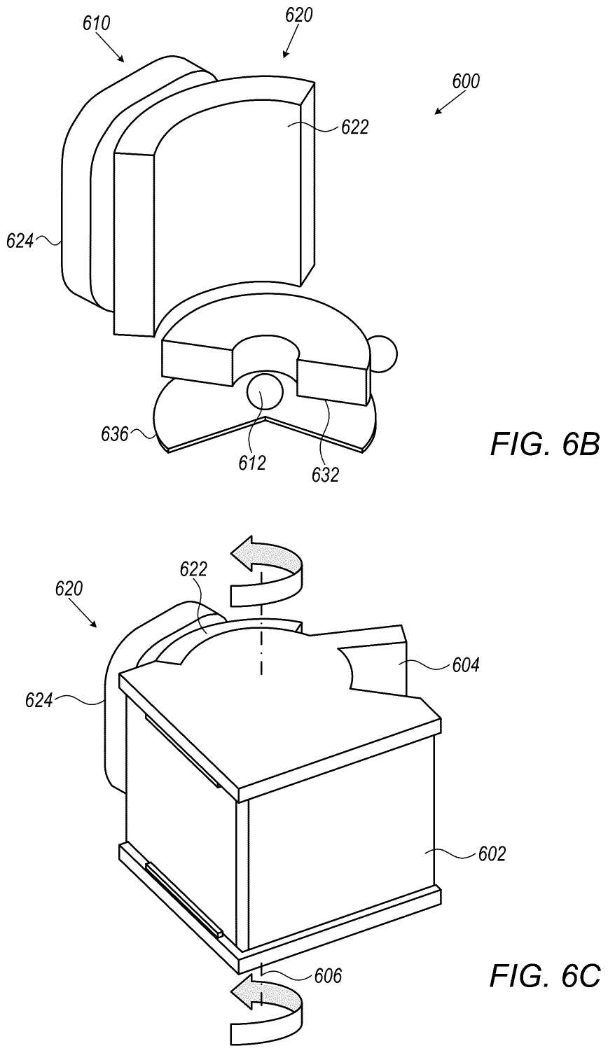

FIG. 6A-C shows a tiltable I-OPFE module 600 that enables tilting an OPFE in a range of about ±30 degrees. FIG. 6A shows I-OPFE module 600 as from a top view. I-OPFE module 600 comprises an I-OPFE 602 (e.g. a mirror or a prism) in an OPFE holder 604, and an OPFE tilt mechanism 610. OPFE tilt mechanism 610 rotates I-OPFE 602 around one axis of rotation 606 located at pivot ball 612 and parallel to the Z-axis. Support balls 614 and 616 mediate the rotation. OPFE tilt mechanism 610 also comprises a voice coil motor (“VCM”) actuator 620 that has a VCM magnet 622 and a VCM coil 624 for rotational actuation. The VCM actuation is sensed by a sensing and compression magnet 632 and a Hall sensor 634.

FIG. 6B shows OPFE module 600 without I-OPFE 602 and OPFE holder 604 in a perspective view. Yoke 636 is visible. FIG. 6C shows OPFE module 600 in the same perspective view as FIG. 2B, but with I-OPFE 602 and OPFE holder 604 shown. The axis of rotation 606 is marked.

By using two separate magnets 622 and 632, OPFE module 600 allows for separation of sensing and actuation. Hall sensor 634 is decoupled from the magnetic field of coil 624. Rotation axis 606 is at relatively large distance from VCM actuator 620, providing a large lever for rotational actuation. Rotation axis 606 is at relatively short distance from Hall sensor 634 so that sensing of large rotational OPFE actuation can be performed within a small stroke.

FIG. 7 shows schematically an embodiment of a mobile device (e.g. a smartphone) capable of tilting a focal plane disclosed herein and numbered 700. Mobile device 700 comprises a SM camera 710 which is a double-folded camera that includes a lens 712, an image sensor 714, an O-OPFE 716 and an O-OPFE actuator 718, an I-OPFE 722 and an I-OPFE actuator 724, both for rotational actuation of O-OPFE and I-OPFE respectively. Rotational actuation of I-OPFE is performed for a method disclosed herein. Calibration data for rotational actuation of I-OPFE according to a control signal from I-OPFE control 744 is stored on a first memory 726 (e.g. an EEPROM or “electrically erasable programmable read-only memory”) or on a third memory 750 (e.g. a NVM or “non-volatile memory”). SM lens 712 may have a fixed EFL providing a fixed zoom factor (ZF), or an adaptable EFL providing an adaptable ZF. The adaptation of the focal length may be discrete or continuous, i.e. a discrete number of varying focal lengths for providing two or more discrete zoom states having particular respective ZFs, or the adaptation of the ZF may be continuous. O-OPFE actuator 718 and I-OPFE actuator 724 may actuate O-OPFE 716 and I-OPFE 722 respectively for focal plane tilting, OIS and, in case SM camera 710 is a scanning folded camera, for FOV scanning. I-OPFE actuator 724 may actuate I-OPFE 722 around two perpendicular axes, in dependence of a desired focal plane tilt direction.

Mobile device 700 further comprises a W camera module 730 including a W lens 732, an image sensor 734 and a second memory 736.

Mobile device 700 may further comprise an application processor (AP) 740. AP 730 comprises an OOI detector 742, a tilt estimator 744 for estimating a relative tilt between mobile device 700 and an OOI that is to be captured. The tilt estimation of 744 is used by I-OPFE control 746 to calculate control signals for I-OPFE actuator 724 which rotates I-OPFE 722 according to the control signals.

SM camera 710 may have an EFL of e.g. 7 mm-50 mm or more, a diagonal FOV of 5 degree-40 degree and a f number of f/#=1.5-7.5. W camera 730 may have an EFL of e.g. 2.5 mm-15 mm, a diagonal FOV of 50 deg-130 deg and f/#=1.0-3.5.

SM camera 710 may be a scanning camera. By rotational actuation of O-OPFE 716 and I-OPFE 722, the native (diagonal) FOV (FOV_{N}) of SM camera 710 can be steered for scanning a scene. FOV_{N} may be 10-40 degrees, and a scanning range of FOV_{N} may be ±5 degree-±35 degree. For example, a scanning SM camera with 20 degree FOV_{N} and ±20 FOV_{N} scanning covers a Tele FOV of 60 degree.

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

All references mentioned in this specification are herein incorporated in their entirety by reference into the specification, to the same extent as if each individual reference was specifically and individually indicated to be incorporated herein by reference. In addition, citation or identification of any reference in this application shall not be construed as an admission that such reference is available as prior art to the present application.

What is claimed is:

1. A method, comprising:
providing an electronic mobile device that includes a Wide camera for capturing a Wide image with a respective Wide field of view FOV_{W}, a super-Macro (SM) camera for capturing a SM image with a respective SM field of view FOV_{sM} smaller than FOV_{W}, and a processor, wherein the SM camera has a focal plane; and
configuring the processor to autonomously tilt the focal plane of the SM camera according to an analysis that uses Wide image data and/or SM image data, and to autonomously capture SM images at a given focal plane tilt.

2. The method of claim 1, wherein the tilting of the focal plane is performed so that a captured SM image is entirely in-focus.

3. The method of claim 1, wherein the tilting of the focal plane is performed so that a captured SM image has a specific amount of out-of-focus deblur.

4. The method of claim 1, wherein the SM camera has an effective focal length of 7-10 mm.

5. The method of claim 1, wherein the SM camera has an effective focal length of 10-20 mm.

6. The method of claim 1, wherein the SM camera has an effective focal length of 20-40 mm.

7. The method of claim 1, further comprising configuring the processor to focus the SM camera to object-lens distances of 3.0-16 cm.

8. The method of claim 1, further comprising configuring the processor to focus the SM camera to object-lens distances of 15-50 cm.

9. The method of claim 1, wherein tilting of the focal plane is by 0-20 degrees.

10. The method of claim 1, wherein the SM camera includes an optical path folding element (OPFE).

11. The method of claim 10, wherein the tilting of the focal plane of the SM camera is obtained by rotating the OPFE.

12. The method of claim 11, wherein the tilting of the focal plane of the SM camera is along two axes and is obtained by rotating the OPFE along two axes.

13. The method of claim 1, wherein the electronics mobile device is a smartphone.

14. An electronic mobile device, comprising:
a super-Macro (SM) camera for capturing a SM image with a respective SM field of view FOV_{SM}, wherein the SM camera has a focal plane and includes an image side optical path folding element (I-OPFE) and wherein the SM camera is configured to tilt its focal plane by rotating the I-OPFE.

15. The electronic mobile device of claim 14, wherein the electronic mobile device includes a processor, and wherein the processor is configured to autonomously tilt the focal plane of the SM camera according to an analysis that uses SM image data, and to autonomously capture SM images at a given focal plane tilt.

16. The electronic mobile device of claim 14, wherein the electronic mobile device includes a Wide camera having a Wide camera field of view FOV_{W}>FOV_{sM}, wherein the electronic mobile device includes a processor, and wherein the processor is configured to autonomously tilt the focal plane of the SM camera according to an analysis that uses Wide image data and to autonomously capture SM images at a given focal plane tilt.

17. The electronic mobile device of claim 14, wherein the SM camera has an effective focal length of 7-40 mm.

18. The electronic mobile device of claim 14, wherein the SM camera is focused to object-lens distances of 3.0-16 cm.

19. The electronic mobile device of claim 14, wherein the electronic mobile device is a smartphone.
